(19) United States
(12) Patent Application Publication
(10) Pub. No.: US 2026/0120144 A1
(43) Pub. Date: Apr. 30, 2026

(54) SYSTEMS AND METHODS TO DYNAMICALLY IMPROVE RETARGETING OF CONTENT FOR AUDIENCES

(71) Applicant: Adeia Guides Inc., San Jose, CA (US)

(72) Inventors: Serhad Doken, Bryn Mawr, PA (US); Tao Chen, Palo Alto, CA (US)

(21) Appl. No.: 18/933,484

(22) Filed: Oct. 31, 2024

(51) Int. Cl. G06Q 30/0251; H04L 65/1066

(52) U.S. Cl. CPC G06Q 30/0255; H04L 65/1066

(57) ABSTRACT

Systems and methods are provided herein for generating customized pieces of content for a user based on the user's preferences and measuring the effectiveness of the customized pieces of content. This may be accomplished by a system identifying one or more objects depicted in a first piece of content and then assigning labels to the one or more objects. The system may determine that a user skipped the first piece of content when the first piece of content was displayed to the user. In response to the user skipping the first piece of content, the system may identify one or more objects depicted in the first piece of content to change. The system may use the assigned labels and user preferences to generate a second piece of content. The second piece of content may then be displayed to the user.

### BACKGROUND

The present disclosure relates to improved customization of media content, and in particular to techniques for automatically customizing media content based on user interactions.

### SUMMARY

Selling advertisement inventory is a common revenue model for many online media companies. For example, many streaming services (e.g., Netflix, Disney, Max, etc.) are moving towards advertisement-based offerings. Many users complain that the advertisements presented by media companies (e.g., streaming services) are repetitive and/or are not relevant to the users. Presenting users with advertisements that are not suitable for them can lead to a negative user experience and wasted advertising budget. A negative user experience may cause the user to consume less media content or even unsubscribe from a service resulting in decreased revenue for the media companies. Further, serving advertisements that are not suited for the users is a waste of valuable advertising budget.

Advertisers looking for online advertisement spaces generally depend upon one or more demand-side platforms (DSPs) to purchase inventory from sellers of online advertisement spaces. The buying and selling of advertisement spaces is generally conducted using real-time bidding (RTB) on an advertising exchange platform. Advertising exchange platforms often use high-speed computing servers and fast networks to facilitate RTB. The buying and selling of advertisement spaces often involves the continuous exchange of bid request data traffic and bid response data traffic between DSP servers and the advertising exchange platform servers over one or more networks. The ingesting of maximum queries per second (QPS) of the DSPs can place a burden on the DSPs' networks, servers, and data centers. Accordingly, there is a need to address the increasing number of queries in an efficient manner.

Some advertisers have attempted to combat these problems by creating multiple versions of an advertisement that all promote the same service or product. Although the advertisements promote the same service or product, they have other attributes that are different. For example, a first advertisement may comprise a video of an actress promoting a product and a second advertisement may comprise a video of an athlete promoting the same product. The advertiser may use an advertising exchange platform to present the first advertisement to female users and present the second advertisement to male users. Although this process may work to increase the relevance of advertisements for some users, this process still results in many users experiencing advertisements that are not interesting to the users. For example, many female users like sports, and may find the second advertisement comprising the video of the athlete more interesting. Similarly, many male users do not like sports, and may find the first advertisement comprising the video of the actress more interesting. In view of these deficiencies, there exists a need for improved systems and methods for customizing advertisements for users.

Accordingly, techniques are disclosed herein for generating customized pieces of content for users based on the user's preferences and measuring the effectiveness of the customized pieces of content. For example, a system may receive a first piece of content (e.g., an advertisement) for a product (e.g., phone) from an advertiser. The system may analyze the first piece of content to categorize different objects depicted in the first piece of content. For example, the first piece of content may depict a person in a room holding a phone. The first piece of content may also display a logo related to the product. The system may use one or more programs (e.g., video processing software) to identify the person as a first object, the room as a second object, the phone as a third object, and the logo as a fourth object. The system may then assign one or more labels to the objects. For example, the system may assign a first label to the first object (e.g., the person) and the second object (e.g., the room). The system may assign a second label to the third object (e.g., phone) and the fourth object (e.g., logo). The first label may correspond to non-product-related objects and the second label may correspond to product-related objects.

The first piece of content is then displayed for a user. The system may receive one or more user interactions from the device that displays the first piece of content for the user. For example, the system may receive a user interaction indicating that the user skipped the first piece of content. In another example, the system may receive a user interaction indicating that the user watched half of the first piece of content before switching to a different piece of media content. The system may determine that one or more portions of the first piece of content should be changed based on the received user interaction. For example, the system may determine that one or more objects of the first piece of content should be changed based on the user skipping the first piece of content.

The system may use the labels assigned to the objects depicted in the first piece of content and object preferences associated with the user when determining which portions of the first piece of content to change. For example, the system may identify the first object (e.g., the person) because the first object has a first label (e.g., indicating that the first object is a non-product-related object) and a first object preference (e.g., the user is not interested in the first object) associated with the user. The system may determine one or more object preferences related to the user using one or more of the methodologies described below. Using the one or more object preferences related to the user may ensure the subsequent versions of the first piece of content are customized for the user. In response to determining that the first object should be changed, the system may use one or more models (e.g., an artificial intelligence model) to generate a second piece of content. In some embodiments, the second piece of content is the same as the first piece of content except the first object (e.g., person) is replaced with a new object (e.g., different person).

The second piece of content may then be displayed for the user. The system may receive one or more additional user interactions from the device that displays the second piece of content for the user. For example, the system may receive an additional user interaction indicating that the user watched the entire second piece of content. The system may then generate one or more reports for the advertiser indicating the effectiveness of the one or more pieces of content. For example, the report may comprise the user interaction associated with the first piece of content and the additional user interaction related to the second piece of content. The report may comprise the results of many iterations of this process. For example, the report may comprise a plurality of user interactions associated with a plurality of users who were presented the first piece of content and a plurality of additional user interaction associated with the plurality of users who were presented the second piece of content. The advertiser may use the reports to more efficiently manage the programmatic RTB process, allocate advertising budgets, and forecast the efficacy of future pieces of content.

As described above, the system may have access to one or more object preferences related to the user. The system may determine the one or more object preferences related to the user by monitoring the user's interactions with a plurality of pieces of content. The plurality of pieces of content may depict objects (e.g., people, products, environments, text, etc.). The system may use the monitored user interactions and information related to the pieces of content consumed by the user to determine one or more object preferences of the user. For example, the user may fully watch a first piece of content that depicts a first object (e.g., first actor) and may skip a second piece of content that depicts a second object (e.g., second actor). Based on the user fully watching the first piece of content, the system may determine that the user has a first object preference (e.g., the user is interested in the first object) related to the first object (e.g., first actor). Based on the user skipping the second piece of content, the system may determine that the user has a second object preference (e.g., the user is not interested in the second object) related to the second object (e.g., second actor).

Although a single user interaction related to a single object is described, any number of interactions and/or objects may be used to determine one or more object preferences related to a user. Further, varying levels of granularities may be used. For example, a first piece of content may comprise four different objects. The user may watch a first segment of the first piece of content that displays the first object and may watch a second segment of the first piece of content that displays the second object. The user may input a skip command once a third segment (displaying the third object) of the first piece of content is shown to the user. The system may determine a first object preference (e.g., the user is interested in the first object) related to the first object, a second object preference (e.g., the user is interested in the second object) related to the second object, and a third object preference (e.g., the user is not interested in the third object) related to the third object based on the user skipping the first piece of content during the third segment.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative flowchart of a process for generating customized content for users based on the user's preferences, and measuring the effectiveness of the customized content, in accordance with some embodiments of the disclosure.

FIG. 2 shows a user device displaying a first piece of content, in accordance with some embodiments of this disclosure.

FIGS. 3A-3D show a user device displaying different pieces of content, in accordance with some embodiments of this disclosure.

FIG. 4 shows an illustrative table, in accordance with some embodiments of this disclosure.

FIG. 5 shows an illustrative block diagram of a media system, in accordance with embodiments of the disclosure.

FIG. 6 shows an illustrative block diagram of a user equipment device system, in accordance with some embodiments of the disclosure.

FIG. 7 shows an illustrative block diagram of a server system, in accordance with some embodiments of the disclosure.

FIG. 8 is an illustrative flowchart of a process for generating customized content for users based on the user's preferences, and measuring the effectiveness of the customized content, in accordance with some embodiments of this disclosure.

FIG. 9 is another illustrative flowchart of a process for generating customized content for users based on the user's preferences, and measuring the effectiveness of the customized content, in accordance with some embodiments of this disclosure.

### DETAILED DESCRIPTION

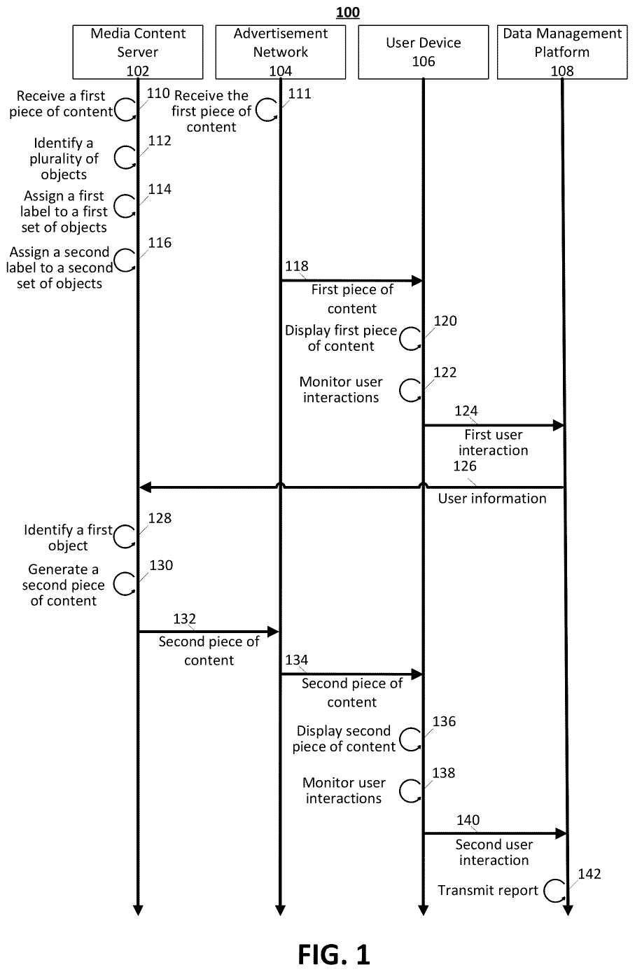

FIG. 1 shows an illustrative flowchart of a process 100 for generating customized content for users based on the user's preferences, and measuring the effectiveness of the customized content, in accordance with some embodiments of the disclosure. In some embodiments, some steps of the process 100 may be performed by one of several devices. Although a media content server 102, an advertisement network 104, a user device 106, and a data management platform 108 are shown, any number of servers and/or devices may be used. For example, although the media content server 102 is displayed as a single server, the media content server 102 may comprise a plurality of servers. In another example, the advertisement network 104 may comprise a DSP, a supply-side platform (SSP), and/or an advertisement exchange platform. Further, different devices may perform different steps of the process 100 than what is shown. Although the process 100 is illustrated and described as a sequence of steps, it is contemplated that various embodiments of the process 100 may be performed in any order or combination and need not include all the illustrated steps. In some embodiments, the user device 106 is a smartphone, laptop, desktop, and/or similar such device.

At step 110, the media content server 102 receives a first piece of content. In some embodiments, the first piece of content is a video, image, and/or audio (e.g., jingle, etc.). In some embodiments, the first piece of content is an advertisement for a product (e.g., phone). The first piece of content may be generated to be a pre-roll advertisement, a mid-roll advertisement, and/or a post-roll advertisement. In some embodiments, the first piece of content is received from one or more advertisers. For example, one or more user devices and/or server associated with an advertiser may transmit the first piece of content to the media content server 102.

At step 111, the advertisement network 104 receives the first piece of content. In some embodiments, the first piece of content is the same or similar to the first piece of content described at step 110 above. In some embodiments, the first piece of content is received from one or more advertisers. In some embodiments, the advertisement network 104 also generates or receives one or more indicators related to the first piece of content. For example, the one or more indicators may indicate that the first piece of content is directed to placement on advertising-based video on demand (AVOD) services and/or free ad-supported streaming television (FAST) services. In another example, the one or more indicators may indicate that the irst piece of content is directed to placement into social media streams. In some embodiments, the indicators influence bidding for advertisement inventory.

At step 112, the media content server 102 identifies a plurality of objects depicted within the first piece of content. For example, the first piece of content may depict a person in a room holding a phone. The first piece of content may also display a logo related to the advertiser. The media content server 102 may identify the person as a first object, the room as a second object, the phone as a third object, and the logo as a fourth object. In some embodiments, the media content server 102 identifies the plurality of objects using object detection, object localization, and/or object segmentation on one or more frames of the first piece of content. In some embodiments, the media content server 102 identifies the plurality of objects using feature matching. For example, the media content server 102 may extract a plurality of features from one or more frames of the first piece of content. The media content server 102 may then use featuring matching to determine that a set of features of the plurality of features relates to an object. For example, a first set of features of the plurality of features may relate to the person (e.g., first object) and a second set of features of the plurality of features may relate to the phone (e.g., third object).

In some embodiments, the media content server 102 may utilize any suitable number or types of image processing techniques to identify the one or more objects. In some embodiments, the media content server 102 may utilize one or more machine learning models (e.g., naive Bayes algorithm, logistic regression, recurrent neural network (RNN), convolutional neural network (CNN), bi-directional long short-term memory recurrent neural network model (LSTM-RNN), or any other suitable model, or any combination thereof) to localize, identify, and/or classify objects in the first piece of content. For example, the machine learning model may output a value, a vector, a range of values, any suitable numeric representation of classifications of objects, or any combination thereof indicative of one or more predicted classifications and/or locations and/or associated confidence values. In some embodiments, the classifications may be understood as any suitable categories into which objects may be classified, identified, and/or characterized. In some embodiments, the model may be trained on a plurality of labeled image pairs, where image data may be preprocessed and represented as feature vectors. For example, the training data may be labeled or annotated with indications of locations of multiple entities and/or indications of the type or class of each entity.

At step 114, the media content server 102 assigns a first label to a first set of objects of the plurality of objects. At step 116, the media content server 102 assigns a second label to a second set of objects of the plurality of objects. For example, the media content server 102 may assign a first label to the first object (e.g., the person) and the second object (e.g., the room) and the media content server 102 may assign a second label to the third object (e.g., phone) and the fourth object (e.g., logo). In some embodiments, the first label may correspond to non-product-related objects and the second label may correspond to product-related objects.

In some embodiments, the media content server 102 determines the first label and/or the second label for the objects using one or more algorithms. For example, the media content server 102 may use an exact similarity search algorithm (e.g., linear search algorithm, binary search algorithm, and/or similar such algorithm), a distance-based search algorithm (e.g., Euclidian distance algorithm, Cosine similarity algorithm, Chi-square distance algorithm, Minkowski distance algorithm, and/or similar such algorithm), an approximate search algorithms (e.g., locality-sensitive hashing, product quantization, KD-Tree, semantic hashing, and/or similar such algorithm), or a graph-based algorithm (e.g., word embedding, graph convolutional network, graph clustering, spectral graph theory, and/or similar such algorithms) to determine to assign the first label to the first object and the second label to the second object.

In some embodiments, the media content server 102 compares the objects identified at step 112 with one or more databases to determine one or more labels to assign to the identified objects. For example, a first database may comprise product-related item attributes and properties. The database may be populated using product catalogs, product-related websites, previous product-related pieces of content, attributes and properties received from advertisers, and/or similar such sources. A second database may comprise non-product-related object. The media content server 102 may run a statistical comparison between the identified items and the first database and/or the second database and assign one or more labels based on the comparison. In some embodiments, audio objects are also assigned metadata. For example, a company jingle may be assigned metadata related to the second label (e.g., product-related) while a piece of dialog (e.g., person introducing themselves) may be assigned metadata related to the first label (e.g., non-product-related).

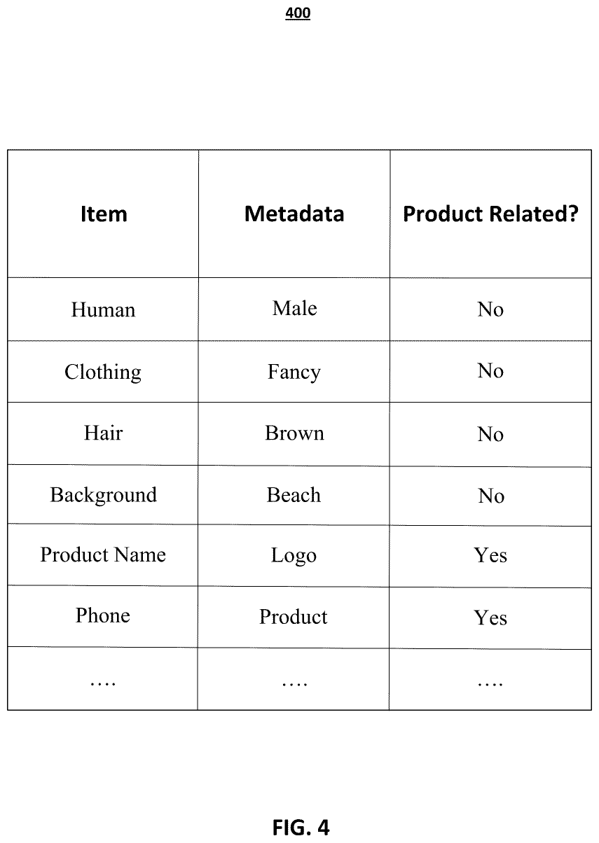

The labels assigned to the objects may be stored as metadata. In some embodiments, the metadata is stored in one or more tables (e.g., table 400 shown in FIG. 4). In some embodiments, the media content server 102 assigns prevalence numbers to the objects based on the size of the objects and/or how long the objects appear in the first piece of content. In some embodiments, a table (e.g., table 400 shown in FIG. 4) is sorted to prioritize objects with the highest prevalence numbers. For example, if the person (e.g., first object) appears throughout the entire first piece of content and the room (e.g., second object) only appears in a portion of the first piece of content, then the person may be assigned a higher prevalence number.

At step 118, the advertisement network 104 transmits the first piece of content to the user device 106. In some embodiments, the advertisement network 104 transmits the first piece of content to the user device 106 in response to a successful bid related to the first piece of content. For example, the user device 106 may be displaying a television show with mid-roll advertisement slots as part of a FAST service. One or more advertisers may bid for advertisement slots within the television show. If the advertiser of the first piece of content submits a winning bid, then the user device 106 receives the first piece of content from the advertisement network 104. The user device 106 may then display the first piece of content, once the user device 106 reaches the mid-roll advertisement slot. At step 120, the user device 106 displays the first piece of content.

At step 122, the user device 106 monitors for user interactions. In some embodiments, the user device 106 uses one or more interfaces and/or sensors to monitor for user interactions. For example, the user device 106 may detect a user interaction when a user inputs a skip, pause, rewind, fast forward, and/or a similar such command using one or more interfaces. In another example, the user device 106 may detect a user interaction when a user saves, shares, and/or bookmarks the first piece of content. In another example, the user device 106 may detect a user interaction when a user inputs a like and/or a comment related to the first piece of content. In another example, a user interaction may correspond to a user watching only a portion of the first piece of content. In another example, a user interaction may correspond to a user rewatching the first piece of content. In another example, the user device 106 may detect a user interaction using a microphone to detect a user speaking words. In some embodiments, the spoken words are analyzed using a natural language processing (NLP) algorithm to determine additional context related to the user's words. In another example, the user device 106 may detect a user interaction using a biometric sensor to detect a change in heart rate of the user. In another example, the user device 106 may detect a user interaction using a camera to detect the gaze of the user (e.g., direction the user is looking) and/or the facial expression of the user.

In some embodiments, one or more other devices may detect the user interaction. For example, a user interaction may correspond to the user scanning a QR code depicted in the first piece of content using another device, transmitting the QR code depicted in the first piece of content to a second device, clicking on a link depicted in the first piece of content, purchasing the product depicted in the first piece of content, performing a search (e.g., using one or more search engines) related to the product, transmitting messages related to the product, completing a survey related to the first piece of content, and/or similar such actions.

At step 124, the user device 106 transmits a first user interaction to the data management platform 108. For example, the user device 106 may transmit a first user interaction indicating that the user skipped the first piece of content after viewing five seconds of the first piece of content. In some embodiments, the user device 106 transmits a plurality of user interactions detected by the user device 106 to the data management platform 108 and the first user interaction is one of the plurality of user interactions. In some embodiments, one or more other devices transmit the first user interaction to the data management platform 108. For example, a second device may transmit a first user interaction indicating that the user performed a search (e.g., using one or more search engines) related to the product depicted in the first piece of content.

At step 126, the data management platform 108 transmits user information to the media content server 102. In some embodiments, the user information comprises the first user interaction received from one or more devices (e.g., user device 106). In some embodiments, the user information also comprises one or more object preferences related to the user. One or more object preferences of the user may be determined by monitoring the user's interactions with a plurality of pieces of content. The plurality of pieces of content may depict objects (e.g., people, products, environments, text, etc.). The data management platform 108 may use the monitored user interactions and information related to the plurality of pieces of content consumed by the user to determine one or more object preferences of the user. For example, the user may fully watch a first piece of content that depicts a first object (e.g., first actor) and may skip a second piece of content that depicts a second object (e.g., second actor). Based on the user fully watching the first piece of content, the data management platform 108 may determine that the user has a first object preference (e.g., the user is interested in the first object) related to the first object (e.g., first actor). Based on the user skipping the second piece of content, the data management platform 108 may determine that the user has a second object preference (e.g., the user is not interested in the second object) related to the second object (e.g., second actor).

Although a single user interaction related to a single object is described, any number of interactions and/or objects may be used to determine one or more object preferences related to a user. Further, varying levels of granularities may be used. For example, a first piece of content may comprise four different objects. The user may watch a first segment of the first piece of content that displays the first object and may watch a second segment of the first piece of content that displays the second object. The user may input a skip command once a third segment (displaying the third object) of the first piece of content is shown to the user. The system may determine a first object preference (e.g., the user is interested in the first object) related to the first object, a second object preference (e.g., the user is interested in the second object) related to the second object, and a third object preference (e.g., the user is not interested in the third object) related to the third object based on the user skipping the first piece of content during the third segment.

In some embodiments, the user information comprises one or more attributes related to the user and/or general object preferences. For example, the user information may indicate that the user associated with the first interaction is a male. The user information may also indicate a first general object preference (e.g., interested in cars) associated with the attribute (e.g., male) related to the user. In another example, the user information may indicate that the user associated with the first interaction prefers comedies. The user information may also indicate a first general object preference (e.g., interested in the actor Ryan Reynolds) associated with the attribute (e.g., users that prefer comedies) related to the user.

At step 128, the media content server 102 identifies a first object of the plurality of objects depicted in the first piece of content. In some embodiments, the media content server 102 identifies a first object of the plurality of objects based on one or more user interactions received from the data management platform 108. For example, the media content server 102 may determine that one or more objects of the first piece of content should be changed based on the user skipping the advertisement. In some embodiments, the media content server 102 determines that one or more objects depicted in a third segment of the first piece of content should be changed based on the user skipping the first piece of content once the third segment of the first piece of content is shown to the user.

In some embodiments, the media content server 102 uses the labels assigned to the objects at step 114 and/or step 116 to identify the first object. For example, the system may identify the first object (e.g., the person) because the first object has a first label (e.g., indicating that the first object is a non-product-related object). In another example, the system may identify the second object (e.g., the room) because the second object has the first label (e.g., indicating that the second object is a non-product-related object). In some embodiments, the media content server 102 uses one or more prevalence numbers associated with the objects to identify the first object. For example, the first object (e.g., person depicted in the first piece of content) may appear throughout the entire first piece of content and a second object (e.g., room depicted in the first piece of content) may only appear in a portion of the first piece of content. Accordingly, the first object may be assigned a higher prevalence value than the second object. The media content server 102 may identify the first object because the first object is assigned the first label and is associated with a higher prevalence number than the second object.

In some embodiments, the media content server 102 uses one or more object preferences to identify the first object. For example, the media content server 102 may receive a first object preference (e.g., the user is not interested in a first actor) related to the user. The media content server 102 may determine that the first object (e.g., the first actor) is related to the received first object preference. The media content server 102 may identify the first object (e.g., the first actor) as an object to be changed based on the first object preference (e.g., the user is not interested in the first actor). In another example, the media content server 102 may receive a first object preference (e.g., the user is interested in a second actor) related to the user. The media content server 102 may determine that the first object (e.g., the first actor) is related to the received first object preference. The media content server 102 may identify the first object (e.g., the first actor) as an object to be changed based on the first object preference (e.g., the user is interested in a second actor).

In some embodiments, the media content server 102 identifies the first object based, at least in part, on one or more user interactions, one or more labels, and/or one or more object preferences. For example, the media content server 102 may identify a set of objects depicted in a third segment of the first piece of content based on the user skipping the first piece of content once the third segment of the first piece of content is shown to the user. The set of objects may comprise the first object (e.g., person), the second object (e.g., room), the third object (e.g., phone), and the fourth object (e.g., logo). The media content server 102 may identify the first object (e.g., person) and the second object (e.g., room) from the set of objects based on the first object and the second object being assigned the first label (e.g., indicating that the object is a non-product-related object). The media content server 102 may then identify the first object based on a first object preference (e.g., the user is not interested in the first object) associated with the user.

At step 130, the media content server 102 generates a second piece of content. In some embodiments, the media content server 102 generates the second piece of content by changing the first object identified at step 128. In some embodiments, the media content server 102 uses one or more models (e.g., an artificial intelligence model) to generate the second piece of content. In some embodiments, the second piece of content is the same as the first piece of content except the first object (e.g., person) is replaced with a different object (e.g., different person). For example, the second piece of content may be the same as the first piece of content except the person (first object) is replaced with a different person (different object). In some embodiments, more than one objects are changed in the second piece of content. For example, the second piece of content may be the same as the first piece of content except the person (first object) is replaced with a different person and the room (second object) is replaced with a different environment.

In some embodiments, the media content server 102 identifies objects to be changed based on any of the factors described herein. For example, the media content server 102 may identify the first object (e.g., person) and the second object (e.g., room) as objects to be changed based on both objects being assigned the first label (e.g., indicating that the objects are non-product-related objects). Accordingly, the second piece of content may be the same as the first piece of content except the person (first object) is replaced with a different person and the room (second object) is replaced with a different environment. In some embodiments, the media content server 102 generates the second piece of content by alternating a prompt given to one or more models (e.g., an artificial intelligence model). For example, an artificial intelligence model may generate the first piece of content in response to a first prompt. The media content server 102 may alter one or more components of the first prompt to generate a second prompt based on any of the factors described herein. The artificial intelligence model may then generate the second piece of content in response to the second prompt.

In some embodiments, the media content server 102 selects replacement objects from one or more databases of objects. When selecting a replacement object, the media content server 102 may identify replacement objects related to the original object. For example, if the first object is a first actor, then the media content server 102 may select a second actor as the replacement object because the first actor and the second actor are both actors. In another example, if the first object is a dog, then the media content server 102 may select a cat as the replacement object because the dog and the cat are both animals. In another example, if the first object is a room, then the media content server 102 may select a beach as the replacement object because the room and the beach are both environments. In some embodiments, the media content server 102 identifies related objects based on metadata related to each object. In some embodiments, the media content server 102 identifies related objects based on one or more attributes related to each object.

In some embodiments, the media content server 102 selects replacement objects based on one or more user interactions. For example, if the first object is a first actor, then the media content server 102 may select a second actor based on a user interaction (e.g., the user watched more than one pieces of content depicting the second actor). In another example, the first object may be the actor with straight hair and the replacement object may be the actor with curly hair.

The media content server 102 may select the actor with curly hair as the replacement object based on a user interaction (e.g., the user completely watches pieces of content depicting the actor with curly hair).

In some embodiments, the media content server 102 determines the number of objects to change based on one or more user interactions. For example, the media content server 102 may select five objects to be changed if the user skips the first piece of content after viewing the first piece of content for three seconds. The media content server 102 may select one object to be changed if the user skips the first piece of content after viewing the first piece of content for thirty seconds. Accordingly, fewer objects may be changed if the user views more of the original piece of content.

In some embodiments, the media content server 102 determines the length of the second piece of content based on one or more user interactions. For example, the media content server 102 may extend the duration of the second piece of content compared to the first piece of content, if the user watches the entire first piece of content. The media content server 102 may reduce the duration of the second piece of content compared to the first piece of content, if the user watches only a portion of the first piece of content.

At step 132, the media content server 102 transmits the second piece of content to the advertisement network 104. In some embodiments, the media content server 102 generates one or more identifiers for the second piece of content based on the changes. The one or more identifiers may be used to identify one or more changes between the first piece of content and the second piece of content. In some embodiments, the identifiers may be used to identify which objects have been previously changed to reduce duplication and ensure changes to the pieces of content occur gradually. The media content server 102 may transmit the identifiers related to the second piece of content to one or more devices. For example, the media content server 102 may transmit the identifiers related to the second piece of content to the data management platform 108.

In some embodiments, one or more devices store data related to the second piece of content. In some embodiments, the data comprises the identifiers generated by the media content server 102. The identifiers related to the second piece of content may be linked to one or more parameters such as unified ID 2.0 (UID2). In some embodiments, data associated with the second piece of content may be:

(User_Profile, Ad_UID2, Skip_Percentage, Ad_Variant)

In some embodiments, the User_Profile identifies a profile of the user. The Ad_UID2 may identify when the second piece of content is displayed. The Skip_Percentage may identify the percentage of times the second piece of content is skipped. The Ad_Variant may be computed as a value associated with the delta between a base piece of content (e.g., the first piece of content) and the second piece of content. In some embodiments, calculating the value associated with the delta includes quantifying the proportionality of the changes between the piece of content in terms of the change in metadata (e.g., change of color of an object, change of size of an object, change of the time of appearance of an object, number of objects that were changed, etc.).

At step 134, the advertisement network 104 transmits the second piece of content to the user device 106. In some embodiments, the advertisement network 104 transmits the second piece of content to the user device 106 in response to a successful retargeting bid. For example, the user device 106 may display the first piece of content during a mid-roll advertisement slot.

The television show being displayed by the user device 106 may also comprise a post-roll advertisement slot. The advertiser may submit a retargeting bid for the post-roll advertisement slot. If the advertiser submits a winning retargeting bid, then the user device 106 receives the second piece of content from the advertisement network 104. The user device 106 may then display the second piece of content, once the user device 106 reaches the post-roll advertisement slot. At step 136, the user device 106 displays the second piece of content.

In some embodiments, the media content server 102 generates the second piece of content based on the device that displays the second piece of content. For example, the first piece of content may be in a first format for a first device (e.g., smartphone). The media content server 102 may determine that the second piece of content is to be displayed on a second device (e.g., extended reality headset). For example, the advertisement network 104 may indicate that the retargeting bid corresponds to an inventory slot for display on the second device (e.g., extended reality headset). In response to determining that the second piece of content is to be displayed on the second device (e.g., extended reality headset), the media content server 102 may generate the second piece of content in a second format for the second device (e.g., extended reality headset).

At step 138, the user device 106 monitors for user interactions. In some embodiments, the user device 106 monitors for user interactions using the same or similar methodologies described at step 122 above. At step 140, the user device 106 transmits a second user interaction to the data management platform 108. For example, the user device 106 may transmit a second user interaction indicating that the user watched the entire second piece of content. In some embodiments, the user device 106 transmits a plurality of user interactions detected by the user device 106 to the data management platform 108 and the second user interaction is one of the plurality of user interactions. In some embodiments, one or more other devices transmit the second user interaction to the data management platform 108. For example, the media content server 102 may transmit a second user interaction indicating that the user purchased the product depicted in the second piece of content to the data management platform 108.

At step 142, the data management platform 108 transmits a report. The report may be transmitted to one or more devices. For example, the data management platform 108 may transmit the report to a second device associated with the advertiser that provided the first piece of content. In some embodiments, the report comprises the first user interaction received at step 124 and the second user interaction received at step 140. For example, the report may indicate that the user skipped the first piece of content and fully watched the second piece of content. In some embodiments, the report also comprises information about the first piece of content and/or the second piece of content. For example, the report may comprise a first identifier indicating that the first piece of content is the original piece of content and the second piece of content is a variant of the first piece of content. In some embodiments, the identifiers also indicate one or more changes related to the piece of content. For example, the report may comprise an identifier indicating that first object (e.g., first actor) was changed to a replacement object (e.g., second actor) in the second piece of content.

In some embodiments, the report comprises a plurality of user interactions. For example, the first piece of content and the second piece of content may be shown to a plurality of users. The data management platform 108 may receive a plurality of user interactions associated with the actions of each user of the plurality of users who viewed the first piece of content and/or the second piece of content. In some embodiments, one or more interactions of the plurality of user interactions are transmitted to one or more advertisement measurement servers (e.g., Google Ad Manager, DoubleClick Campaign Manager, Amazon Advertising Reports, and/or similar such servers). In some embodiments, the data management platform 108 summarizes the plurality of user interactions for each piece of content. For example, the report may indicate that 60% more users skipped the first piece of content compared to the second piece of content. In some embodiments, different user interactions are assigned different values based on different campaigns. For example, purchasing the product depicted in the piece of content may be given a higher value than the user watching the entire piece of content. The data management platform 108 may use the values assigned to the set of user interactions associated with each piece of content to determine which piece of content generated the highest value user interactions.

Although only two pieces of content are described, process 100 may be repeated for a plurality of pieces of content. In some embodiments, the report comprises one or more identifiers for each piece of content of the plurality of pieces of content and one or more user interactions associated with each piece of content. For example, the first piece of content may be assigned a first identifier indicating that the first piece of content is the original piece of content. The second piece of content may be assigned a second identifier indicating that the first object (e.g., first actor) was changed to a replacement object (e.g., second actor) in the second piece of content. A third piece of content may be assigned a third identifier indicating that the second object (e.g., room) was changed to a replacement object (e.g., beach) in the third piece of content. The report may also indicate that 60% of users skipped the first piece of content, 20% of users skipped the second piece of content, and 40% of users skipped the third piece of content. The report may assist the advertisers in generating pieces of content that users are more interested in.

In some embodiments, the data management platform 108 determines that further retargeting is not necessary. For example, the data management platform 108 may receive a plurality of user interactions associated with the second piece of content. The number of user interactions corresponding to the users viewing the entire second piece of content may exceed a threshold. For example, the data management platform 108 may determine that 90% of users viewed the entire second piece of content without inputting a skip command. Based on the plurality of user interactions exceeding a threshold (e.g., 80% of users viewed the entire second piece of content without inputting a skip command) the data management platform 108 may determine that further retargeting is no longer necessary. In some embodiments, the data management platform 108 transmits a notification to the advertiser and/or includes this determination in the report. In some embodiments, the data management platform 108 transmits a notification to the media content server 102 indicating that additional pieces of content do not need to be generated based on the plurality of user interactions associated with the second piece of content (e.g., 90% of users viewed the entire second piece of content without inputting a skip command).

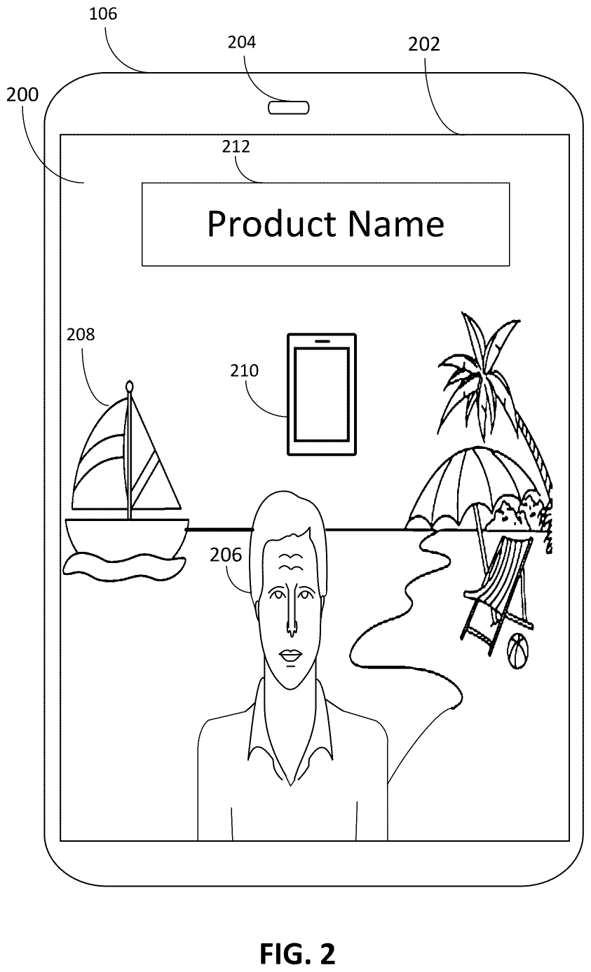

FIG. 2 shows the user device 106 displaying a first piece of content 200, in accordance with some embodiments of this disclosure. In some embodiments, the user device 106 comprises a display 202 and a camera 204. The user device 106 may be a mobile device (e.g., a smartphone, a tablet, etc.), a laptop, a desktop computer, a wearable device, smart glasses, a stereoscopic display, a wearable camera, AR glasses, an AR head-mounted display (HMD), a virtual reality (VR) HMD and/or any other similar such device. In some embodiments, user device 106 displays the first piece of content 200 depicting a first object 206, a second object 208, a third object 210, and a fourth object 212.

In some embodiments, one or more devices (e.g., the media content server 102) identifies and/or classifies the one or more objects depicted in the first piece of content 200. For example, one or more devices may identify the first object 206, the second object 208, the third object 210, and the fourth object 212. The one or more devices may also identify the first object 206 as a person, identify the second object 208 as a boat, identify the third object 210 as a phone, and identify the fourth object 212 as a logo. In some embodiments, the one or more devices identify the plurality of objects using object detection, object localization, object segmentation, feature matching, and/or similar such methodologies. In some embodiments, one or more devices also assign labels to one or more objects. For example, the one or more objects may assign the first object 206 and the second object 208 a first label and may assign the third object 210 and the fourth object 212 a second label. In some embodiments, the first label may correspond to non-product-related objects and the second label may correspond to product-related objects. The one or more objects may assign the one or more labels using one or more of the algorithms and/or models described herein.

The user device 106 may monitor one or more user interactions related to the display of the first piece of content 200. In some embodiments, the user device 106 uses one or more interfaces and/or sensors to monitor for user interactions. For example, the user device 106 may detect a user interaction when a user inputs a skip, pause, rewind, fast forward, and/or a similar such command using the display 202 (e.g., touch screen). In another example, the user device 106 may detect a user interaction when a user saves, sends, and/or bookmarks the first piece of content 200. In another example, the user device 106 may detect a user interaction when a user inputs a like and/or a comment related to the first piece of content 200. In another example, a user interaction may correspond to a user watching only a portion of the first piece of content 200. In another example, the user device 106 may detect a user interaction using the camera 204 to detect the gaze of the user (e.g., direction the user is looking) and/or the facial expression of the user.

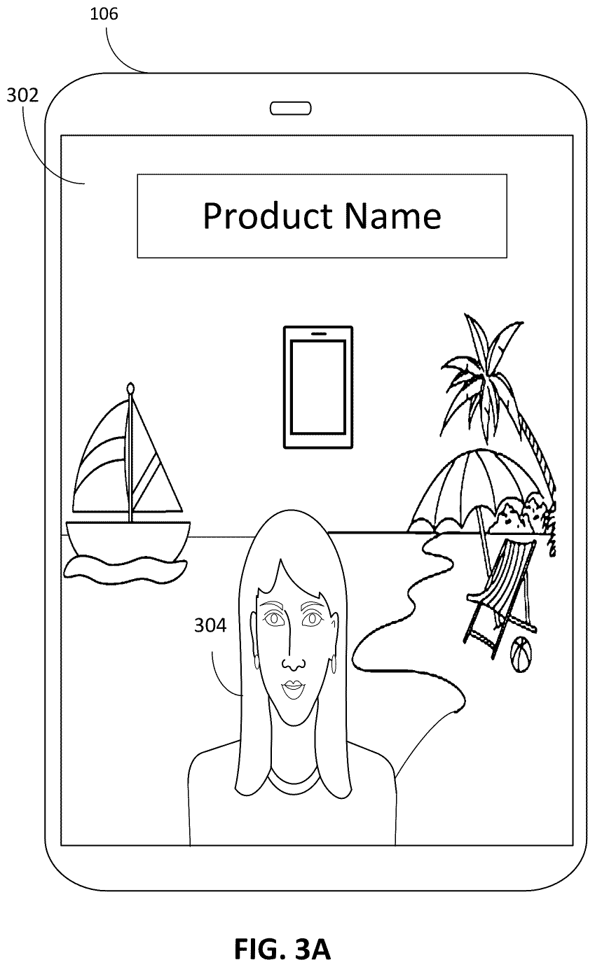

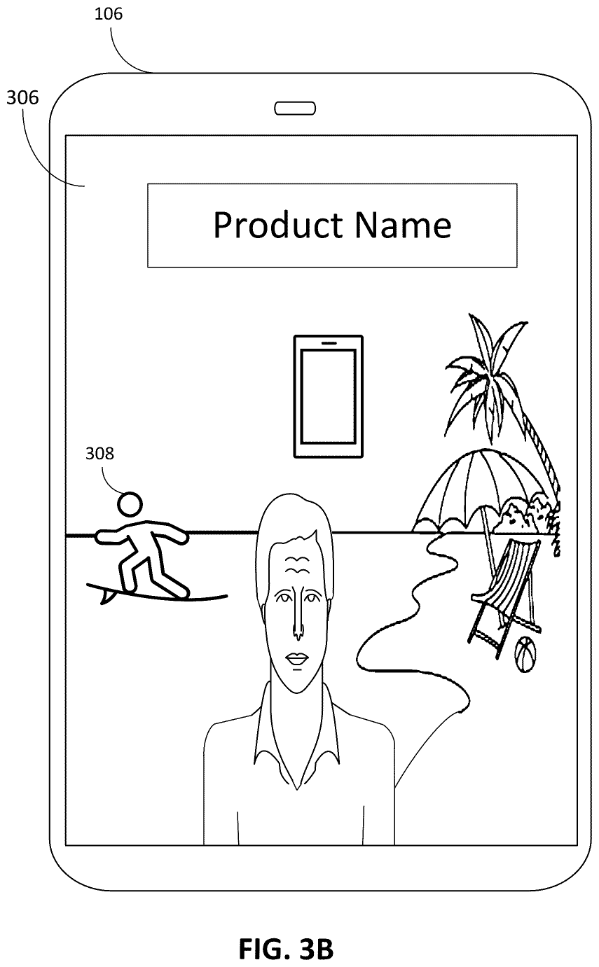

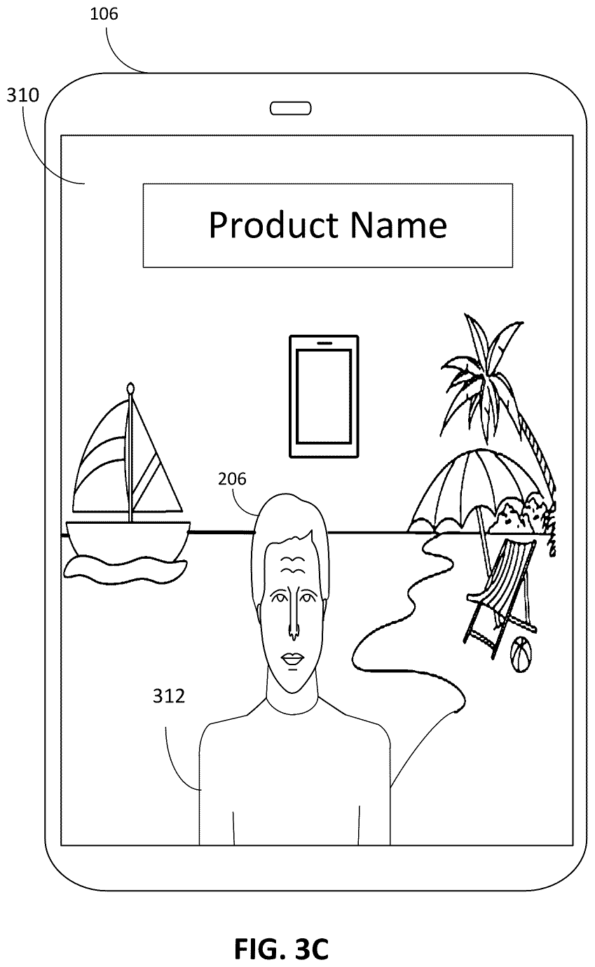

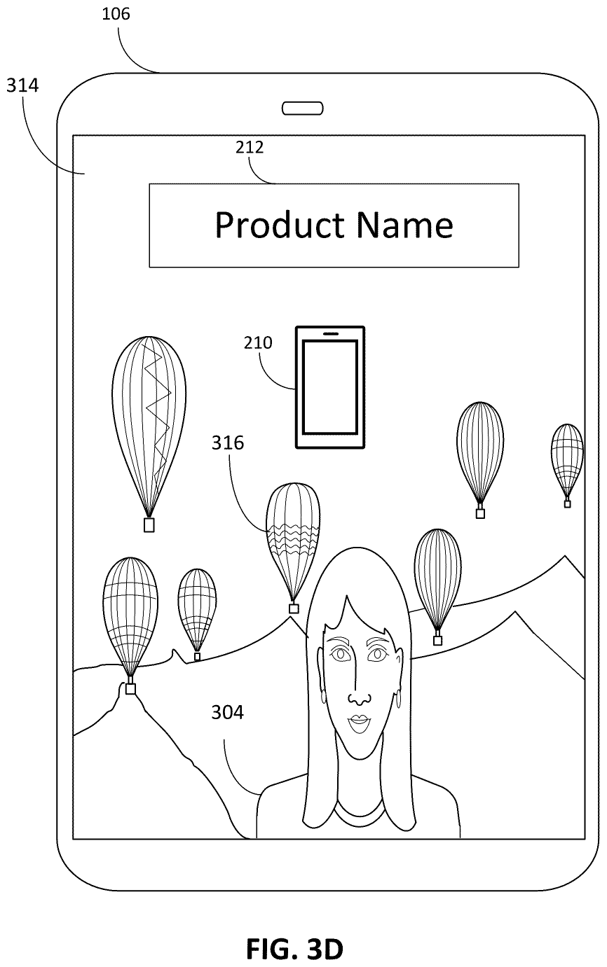

FIGS. 3A-3D show the user device 106 displaying different pieces of content, in accordance with some embodiments of this disclosure. In some embodiments, the different pieces of content are variants of the first piece of content 200. In some embodiments, one or more devices (e.g., the media content server 102) generate the different pieces of content based, at least in part, on one or more user interactions with the first piece of content 200, one or more labels associated with one or more objects depicted in the first piece of content 200, and/or one or more object preferences. In some embodiments, one or more devices use one or more models (e.g., an artificial intelligence model) to generate the different pieces of content.

FIG. 3A shows the user device 106 displaying a second piece of content 302, in accordance with some embodiments of this disclosure. In some embodiments, the second piece of content 302 is the same as the first piece of content 200 except the first object 206 is replaced with a fifth object 304. In some embodiments, one or more devices generate the second piece of content 302 based on a user interaction (e.g., a user skipping the first piece of content 200), the first object 206 having a first label (e.g., indicating that the first object 206 is a non-product-related object), and/or an object preference (e.g., the user is not interested in the first object 206) associated with a user.

FIG. 3B shows the user device 106 displaying a third piece of content 306, in accordance with some embodiments of this disclosure. In some embodiments, the third piece of content 306 is the same as the first piece of content 200 except the second object 208 is replaced with a sixth object 308. In some embodiments, one or more devices generate the third piece of content 306 based on a user interaction (e.g., a user skipping the first piece of content 200), the second object 208 having a first label (e.g., indicating that the first object 206 is a non-product-related object), and/or a second object preference (e.g., the user is interested in surfing) associated with a user.

FIG. 3C shows the user device 106 displaying a fourth piece of content 310, in accordance with some embodiments of this disclosure. In some embodiments, the fourth piece of content 310 is the same as the first piece of content 200 except a portion of the first object 206 is changed. The clothes worn by the person are changed from a first outfit (e.g., displayed in FIG. 2) to a second outfit 312. In some embodiments, one or more devices generate the fourth piece of content 310 based on a user interaction (e.g., a user skipping the first piece of content 200), the first object 206 having a first label (e.g., indicating that the first object 206 is a non-product-related object), and/or an object preference (e.g., the user prefers less formal clothing) associated with a user.

FIG. 3D shows the user device 106 displaying a fifth piece of content 314, in accordance with some embodiments of this disclosure. In some embodiments, the fifth piece of content 314 is similar to the first piece of content 200. For example, both the first piece of content 200 and the fifth piece of content 314 comprise the third object 210 and the fourth object 212. In some embodiments, the third object 210 and the fourth object 212 are not changed because they have a second label (e.g., indicating that the third object 210 and the fourth object 212 are product-related objects). In some embodiments, one or more devices generate the fifth piece of content 314 based on a user interaction (e.g., a user skipping the first piece of content 200), the first object 206 and the second object 208 having a first label (e.g., indicating that the first object 206 and the second object 208 are non-product-related objects), a first object preference (e.g., the user is interested in a seventh object 316) associated with a user, and/or a second object preference (e.g., the user is not interested in the first object 206).

FIG. 4 shows an illustrative table 400, in accordance with some embodiments of this disclosure. Table 400 is just one example of a table used to store metadata associated with one or more objects, similar such tables may be used. For example, different column and row values may be used as would be clear to a person of ordinary skill in the art. In some embodiments, each row corresponds to an object and/or a portion of an object depicted in a piece of content. For example, the first row may correspond to the first object 206 depicted in the first piece of content 200 and the sixth row may correspond to the third object 210 depicted in the first piece of content 200. In some embodiments, the table 400 comprises metadata associated with one or more objects depicted in a piece of content. For example, the table 400 may indicate that the first object 206 is a depiction of a male. In some embodiments, the table 400 indicates one or more labels associated with one or more objects depicted in a piece of content. For example, the first row indicates that the first object 206 depicted in the first piece of content 200 is not a product-related object and the sixth row indicates that the third object 210 is a product-related object. In some embodiments, the table 400 may be stored by one or more devices (e.g., the media content server 102). In some embodiments, the table 400 is transmitted to one or more devices (e.g., the data management platform 108).

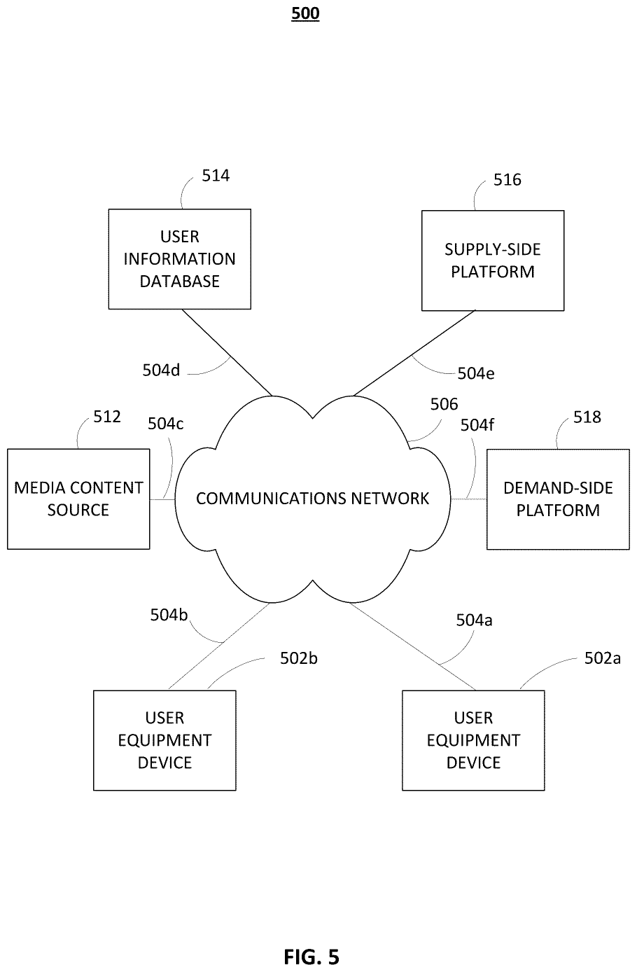

FIGS. 5-7 describe exemplary devices, systems, servers, and related hardware for generating customized advertisements for users based on the user's preferences and/or for measuring the effectiveness of the customized advertisements. In the system 500, there can be more than two user equipment devices 502 but only a first user equipment device 502a and a second user equipment device 502b are shown in FIG. 5 to avoid overcomplicating the drawing. In addition, users may utilize more than one type of user equipment device 502 and more than one of each type of user equipment device. In an embodiment, there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices 502 may also communicate with each other directly through an indirect path via the communications network 506.

The user equipment devices 502, a media content source 512, a user information database 514, a supply-side platform 516, and/or a demand-side platform 518, may be coupled to communications network 506. Namely, the first user equipment device 502a is coupled to the communications network 506 via a first communications path 504a, the second user equipment device 502b is coupled to the communications network 506 via a second communications path 404b, the media content source 512 is coupled to the communications network 506 via a third communications path 504c, the user information database 514 is coupled to the communications network 506 via a fourth communications path 504d, the supply-side platform 516 is coupled to the communications network 506 via a fifth communications path 504e, and the demand-side platform 518 is coupled to the communications network 506 via a sixth communications path 504f. The communications network 506 may be one or more networks including the Internet, a mobile phone network, mobile voice or data network (e.g., a 4G, 5G, or LTE network), cable network, public switched telephone network, or other types of communications network or combinations of communications networks. The paths 504 may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In one embodiment, the paths 504 can be a wireless path. Communication between devices may be provided by one or more communications paths but is shown as a single path in FIG. 5 to avoid overcomplicating the drawing.

The media content source 512 represents any computer-accessible source of content, such as a storage for video content, audio content, metadata, or similar such information. In some embodiments, the media content source 512 stores media content received from one or more devices (e.g., a media content provider, an advertiser, the first user equipment device 502a, etc.). In some embodiments, the media content source 512 may store, execute, and/or have access to various software modules for generating customized media content for users based on the user's preferences and/or for measuring the effectiveness of the customized advertisements. For example, the media content source 512 may store or have access to one or more artificial intelligence programs used to generated customized media content. The media content source 512 may be coupled to any number of databases (e.g., the user information database 514). For example, the media content source 512 may have access to advertisement data, object data, user information, encryption data, and/or similar such information. The media content source 512 may comprise one or more devices (e.g., servers). In the system 500, there can be more than one media content source 512 but only one is shown in FIG. 5 to avoid overcomplicating the drawing.

In some embodiments, one or more user equipment devices may access the demand-side platform 518. For example, the second user equipment device 502b may use the demand-side platform 518 to enter one or more bids for advertising inventory. The demand-side platform 518 may communicate with the supply-side platform 516. In some embodiments, the demand-side platform 518 bids for advertisement inventory available on the supply side-platform using one or more advertisement exchange platforms. In the system 500, there can be more than one demand-side platform 518 and/or supply-side platform 516 but only one of each is shown in FIG. 5 to avoid overcomplicating the drawing. The demand-side platform 518 and/or the supply-side platform 516 may comprise one or more devices (e.g., servers) and may have access to one or more databases.

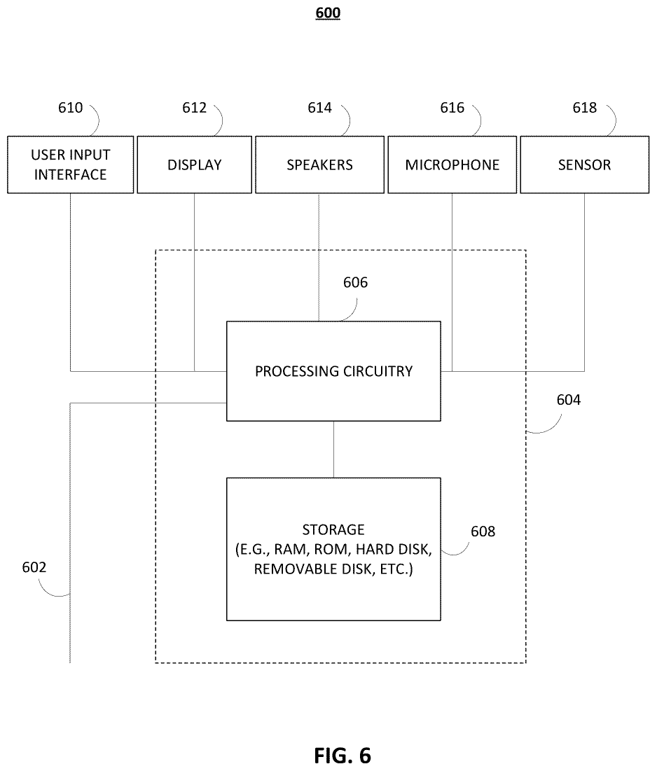

FIG. 6 shows a generalized embodiment of a user equipment device 600, in accordance with one embodiment. In an embodiment, the user equipment device 600 is an example of the user equipment devices described in FIGS. 1-3D and 5 (e.g., user device 106, user equipment devices 502). The user equipment device 600 may receive content and data via input/output (I/O) path 602. The I/O path 602 may provide audio content (e.g., broadcast programming, on-demand programming, Internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The generating of customized advertisements for users based on the user's preferences and/or the measuring of the effectiveness of the customized advertisements functionality can be at least partially implemented using the control circuitry 604. The generating of customized advertisements for users based on the user's preferences and/or the measuring of the effectiveness of the customized advertisements functionality described herein may be implemented in or supported by any suitable software, hardware, or combination thereof. The generating of customized advertisements for users based on the user's preferences and/or the measuring of the effectiveness of the customized advertisements can be implemented on user equipment, on remote servers, or across both.

In client-server-based embodiments, the control circuitry 604 may include communications circuitry suitable for communicating with one or more servers that may at least implement the described generating of customized advertisements for users based on the user's preferences and/or the measuring of the effectiveness of the customized advertisements functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604, which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. A speaker 614 may be controlled by the control circuitry 604. The speaker (or speakers) 614 may be provided as integrated with other elements of user equipment device 600 or may be a stand-alone unit. In some embodiments, the display 612 may be output through speaker 614.

In an embodiment, the display 612 is a headset display (e.g., when the user equipment device 600 is an extended reality headset). The display 612 may be an optical see-through (OST) display, wherein the display includes a transparent plane through which objects in a user's physical environment can be viewed by way of light passing through the display 612. The user equipment device 600 may generate for display virtual or augmented objects to be displayed on the display 612, thereby augmenting the real-world scene visible through the display 612. In an embodiment, the display 612 is a video see-through (VST) display. In some embodiments, the user equipment device 600 may optionally include a sensor 618. Although only one sensor 618 is shown, any number of sensors may be used. In some embodiments, the sensor 618 is a camera, depth sensors, Lidar sensor, and/or any similar such sensor. In some embodiments, the sensor 618 (e.g., image sensor(s) or camera(s)) of the user equipment device 600 may capture the real-world environment around the user equipment device 600. The user equipment device 600 may then render the captured real-world scene on the display 612. The user equipment device 600 may generate for display virtual or augmented objects to be displayed on the display 612, thereby augmenting the real-world scene visible on the display 612.

Control circuitry 604 may include video generating circuitry and tuning circuitry, such as one or more analog tuners, one or more MPEG-2 decoders or MPEG-4 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format. Control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from the user equipment device 600, the tuning and encoding circuitry (including multiple tuners) may be associated with storage 608.

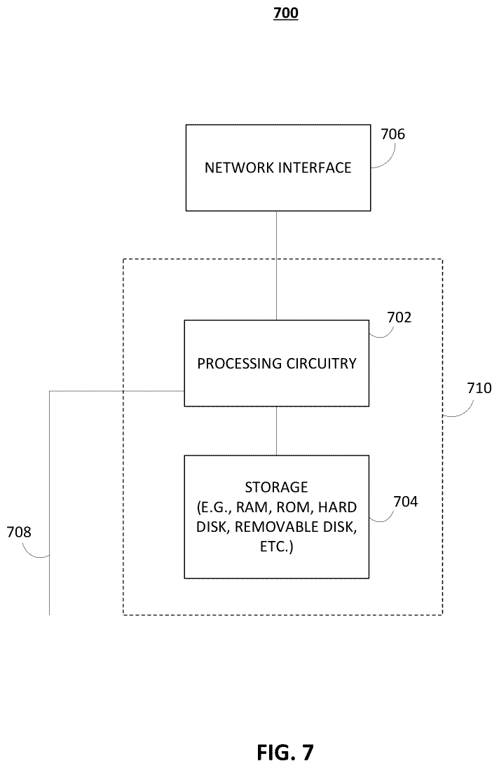

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images, videos, audio, etc.), models, or modules or may provide various executable applications or modules. In practice, and as recognized by those of ordinary skill in the art, items shown separately could be combined and some items could be separated. In some embodiments, not all shown items must be included in server system 700. In some embodiments, server system 700 may comprise additional items.

The server system 700 can include processing circuitry 702 that includes one or more processing units (processors or cores), storage 704, one or more network or other communications network interfaces 706, and one or more I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O path 708 may provide data to control circuitry 710, which includes processing circuitry 702 and a storage 704. The control circuitry 710 may be used to send and receive commands, requests, and other suitable data using the I/O path 708. The I/O path 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware dependent tasks. In some embodiments, storage 704 or the computer-readable storage medium of the storage 704 stores a communications module, which is used for connecting the server system 700 to other computers and devices via the one or more communication network interfaces 706 (wired or wireless), such as the internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for advertisement data, object data, user information data, encryption data, and/or similar such information.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 may store additional modules or data structures not described above.

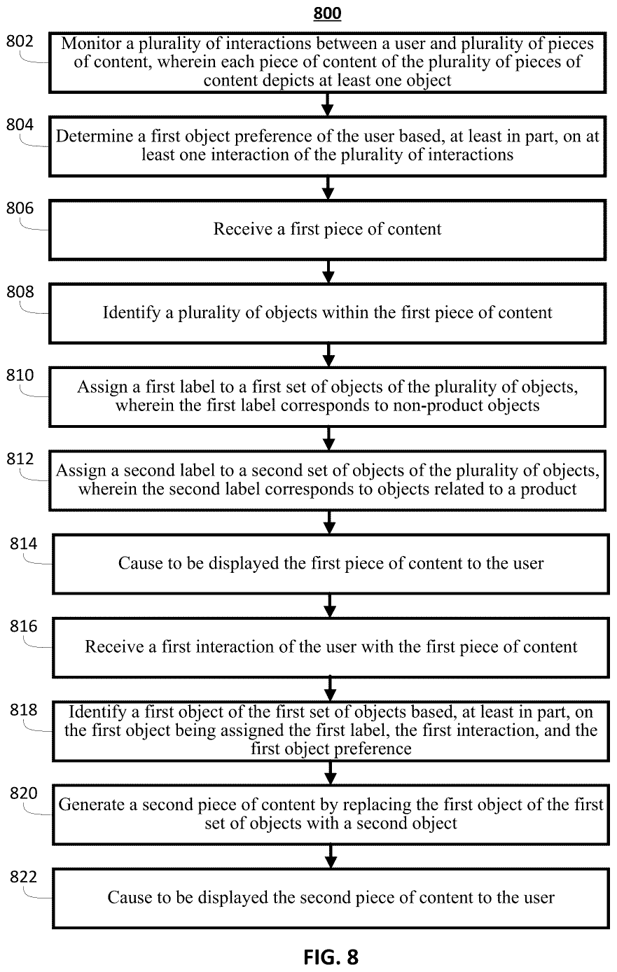

FIG. 8 is an illustrative flowchart of a process 800 for generating customized content for users based on the user's preferences. Process 800, and any of the following processes, may be executed by control circuitry 604 on a user equipment device 600 and/or control circuitry 710 on a server system 700. In some embodiments, control circuitry may be part of a remote server separated from the user equipment device 600 by way of a communications network or distributed over a combination of both. In some embodiments, instructions for executing process 800 may be encoded onto a non-transitory storage medium (e.g., the storage 608, the storage 704) as a set of instructions to be decoded and executed by processing circuitry (e.g., the processing circuitry 606, the processing circuitry 702). Processing circuitry may, in turn, provide instructions to other sub-circuits contained within control circuitry, such as the encoding, decoding, encrypting, decrypting, scaling, analog/digital conversion circuitry, and the like. It should be noted that any of the processes, or any step thereof, could be performed on, or provided by, any of the devices described in FIGS. 1-3D and 5-7. Although the processes are illustrated and described as a sequence of steps, it is contemplated that various embodiments of the processes may be performed in any order or combination and need not include all the illustrated steps.

At 802, control circuitry monitors a plurality of interactions between a user and a plurality of pieces of content, wherein each piece of content of the plurality of pieces of content depicts at least one object. In some embodiments, the plurality of interactions are stored as a watch history related to the user. The control circuitry may monitor for a plurality of interactions by receiving the watch history of a user from one or more devices. In some embodiments, the control circuitry uses one or more interfaces and/or sensors to monitor for user interactions. In some embodiments, the control circuitry detects the plurality of interactions using information received from one or more other devices. For example, one or more devices may detect an interaction when a user inputs a skip command while the one or more devices are displaying a piece of content comprising an object. The one or more other devices may transmit the detected interaction (e.g., user inputting a skip command) and information about the piece of content (e.g., the piece of content comprises an object) associated with the detected interaction to the control circuitry. In another example, one or more devices may detect an interaction when a user performs a search (e.g., using one or more search engines) related to a product depicted in a piece of content. The one or more other devices may transmit the detected interaction (e.g., user performing a search related to the depicted product) and information about the piece of content (e.g., the piece of content depicts the product) associated with the detected interaction to the control circuitry.

At 804, control circuitry determines a first object preference of the user based, at least in part, on at least one interaction of the plurality of interactions. In some embodiments, the first object preference is associated with a first object depicted in at least one piece of content of the plurality of pieces of content. For example, the user may fully watch a first piece of content that depicts a first object (e.g., first actor) and may skip a second piece of content that depicts a second object (e.g., second actor). Based on the user fully watching the first piece of content, the system may determine that the user has a first object preference (e.g., the user is interested in the first object) related to the first object (e.g., first actor). Based on the user skipping the second piece of content, the system may determine that the user has a second object preference (e.g., the user is not interested in the second object) related to the second object (e.g., second actor). In some embodiments, any number of interactions and/or objects may be used to determine one or more object preferences related to a user and varying levels of granularities may be used.

At 806, control circuitry receives a first piece of content. In some embodiments, the first piece of content is a video or an image. In some embodiments, the first piece of content is an advertisement for a product (e.g., phone). In some embodiments, the first piece of content is received from one or more advertisers. For example, one or more user devices and/or servers associated with an advertiser may transmit the first piece of content to the control circuitry. In some embodiments, the first piece of content is received from a DSP and/or an advertising exchange platform.

At 808, control circuitry identifies a plurality of objects within the first piece of content. For example, the first piece of content may depict a person in a room holding a phone. The first piece of content may also display a logo related to the advertiser. The control circuitry may identify the person as a first object, the room as a second object, the phone as a third object, and the logo as a fourth object.

In some embodiments, the control circuitry identifies the plurality of objects using object detection, object localization, and/or object segmentation on one or more frames of the first piece of content. In some embodiments, the control circuitry identifies the plurality of objects using feature matching. For example, the control circuitry may extract a plurality of features from one or more frames of the first piece of content. The control circuitry may then use featuring matching to determine that a set of features of the plurality of features relates to an object. For example, a first set of features of the plurality of features may relate to the person (e.g., first object) and a second set of features of the plurality of features may relate to the phone (e.g., third object). In some embodiments, the control circuitry may utilize any suitable number or types of image processing techniques to identify the one or more objects. In some embodiments, the control circuitry may utilize one or more machine learning models to localize, identify, and/or classify objects in first piece of content.

At 810, control circuitry assigns a first label to a first set of objects of the plurality of objects, wherein the first label corresponds to non-product objects. At 812, control circuitry assigns a second label to a second set of objects of the plurality of objects, wherein the second label corresponds to objects related to a product. For example, the control circuitry may assign the first object (e.g., the person) and the second object (e.g., the room) a first label and the control circuitry may assign the third object (e.g., phone) and the fourth object (e.g., logo) a second label. In some embodiments, the first label may correspond to non-product-related objects and the second label may correspond to product-related objects. In some embodiments, the control circuitry determines the first label and/or the second label for the objects using one or more algorithms.

In some embodiments, the control circuitry compares the objects identified at step 808 with one or more databases to determine one or more labels to assign to the identified objects. For example, a first database may comprise product-related item attributes and properties. The database may be populated using product catalogs, product-related websites, previous product-related pieces of content, attributes and properties received from advertisers, and/or similar such sources. A second database may comprise non-product-related object. The control circuitry may run a statistical comparison between the identified items and the first database and/or the second database and assign one or more labels based on the comparison. The labels assigned to the objects may be stored as metadata. In some embodiments, the metadata is stored in one or more tables (e.g., table 400 shown in FIG. 4).

At 814, control circuitry causes to be displayed the first piece of content to the user. In some embodiments, the control circuitry transmits the first piece of content to a user device (e.g., user device 106 shown in FIG. 1). In some embodiments, the control circuitry transmits the first piece of content to one or more devices that transmit the first piece of content to the user device. For example, the control circuitry may transmit the first piece of content to one or more devices in an advertisement network (e.g., advertisement network 104 shown in FIG. 1) and the one or more devices transmit the first piece of content to one or more user devices. In some embodiments, the one or more devices in the advertisement network transmit the first piece of content to a user device in response to a successful bid related to the first piece of content. For example, a user device may be displaying a television show with mid-roll advertisement slots as part of a FAST service. One or more advertisers may bid for advertisement slots within the television show. If the advertiser of the first piece of content submits a winning bid, then the user device may receive the first piece of content from the one or more devices in the advertisement network. The user device may then display the first piece of content, once the user device reaches a mid-roll advertisement slot.

At 816, control circuitry receives a first interaction of the user with the first piece of content. In some embodiments, the control circuitry uses the same or similar methodologies described at step 802 to receive the first interaction. In some embodiments, the control circuitry receives the first interaction from the device that displays the first piece of content at step 814. For example, the device that displays the first piece of content at step 814 may receive a skip command while displaying the first piece of content. The devices may then transmit the detected interaction (e.g., skip command) and information about the first piece of content (e.g., piece of content identifier) associated with the detected interaction to the control circuitry. In some embodiments, the control circuitry receives the first interaction from one or more other devices. For example, one or more devices may detect a user interaction when a user performs a search (e.g., using one or more search engines) related to a product depicted in the first piece of content. The one or more other devices may transmit the detected interaction (e.g., user performing a search related to the depicted product) to the control circuitry.

At 818, control circuitry identifies a first object of the first set of objects based, at least in part, on the first object being assigned the first label, the first interaction, and the first object preference. For example, the control circuitry may identify a set of objects depicted in a third segment of the first piece of content based on the first interaction (e.g., the user skipping the first piece of content once the third segment of the first piece of content is shown to the user) received at step 816. The set of objects may comprise a first object (e.g., person), a second object (e.g., room), a third object (e.g., phone), and a fourth object (e.g., logo). The control circuitry may identify the first object (e.g., person) and the second object (e.g., room) from the set of objects based on the first object and the second object being assigned the first label (e.g., indicating that the object is a non-product-related object) at step 810. The control circuitry may then identify the first object based on a first object preference (e.g., the user is not interested in the first object) associated with the user determined at step 804.

At 820, control circuitry generates a second piece of content by replacing the first object of the first set of objects with a second object. In some embodiments, the control circuitry generates the second piece of content be changing the first object identified at step 818. In some embodiments, the control circuitry uses one or more models (e.g., an artificial intelligence model, text-to-image model (e.g., Dall-E, Runway, etc.), and/or similar such models) to generate the second piece of content. For example, the control circuitry may input the first piece of content and an identifier (identifying the first object) into an artificial intelligence model and the artificial intelligence model output the second piece of content where the first object of the first set of objects is replaced with a second object. In some embodiments, the second piece of content is the same as the first piece of content except the first object (e.g., person) is replaced with a different object (e.g., different person). For example, the second piece of content may be the same as the first piece of content except the person (first object) is replaced with a different person (different object). In some embodiments, more than one objects are changed in the second piece of content. For example, the second piece of content may be the same as the first piece of content except the person (first object) is replaced with a different person and the room (second object) is replaced with a different environment.

In some embodiments, the control circuitry selects replacement objects from one or more databases of objects. When selecting a replacement object, the control circuitry may identify replacement objects related to the original object. For example, if the first object is a first actor, then the control circuitry may select a second actor as the replacement object because the first actor and the second actor are both actors. In some embodiments, the control circuitry identifies related objects based on metadata related to each object. In some embodiments, the control circuitry identifies related objects based on one or more attributes related to each object. In some embodiments, the control circuitry selects replacement objects based on one or more object preferences and/or user interactions. For example, if the first object is a first actor, then the control circuitry may select a second actor based on an object preference (e.g., the user is interested in pieces of content depicting the second actor).

At 822, control circuitry causes to be displayed the second piece of content to the user. In some embodiments, the control circuitry causes the second piece of content to be displayed using the same or similar methodologies described at step 814. In some embodiments, the control circuity and/or one or more devices of an advertisement network transmits the second piece of content to one or more user devices in response to a successful retargeting bid. For example, a user device (e.g., the user device described at step 814) may display the first piece of content during a mid-roll advertisement slot. The television show displayed at the user device may also comprise a post-roll advertisement slot. The advertiser may submit a retargeting bid for the post-roll advertisement slot. If the advertiser submits a winning retargeting bid, then the user device receives the second piece of content from the control circuity and/or one or more devices of the advertisement network. The user device may then display the second piece of content, once the user device reaches the post-roll advertisement slot.

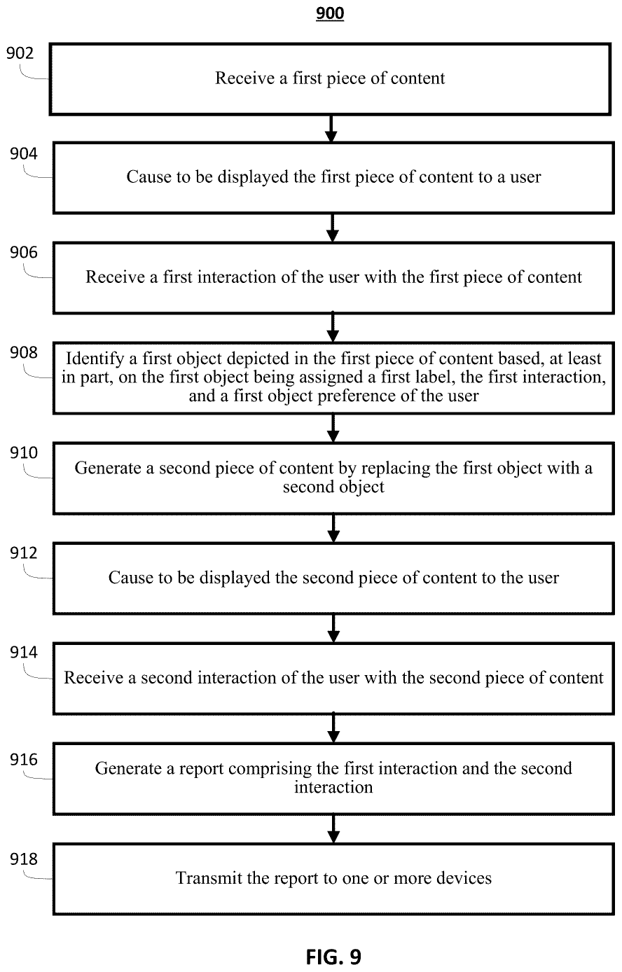

FIG. 9 is an illustrative flowchart of a process 900 for generating customized content for users based on the user's preferences and measuring the effectiveness of the customized advertisements, in accordance with some embodiments of this disclosure.

At 902, control circuitry receives a first piece of content. In some embodiments, the control circuitry uses the same or similar methodologies described at step 806 above to receive the first piece of content.

At 904, control circuitry causes to be displayed the first piece of content to a user. In some embodiments, the control circuitry uses the same or similar methodologies described at step 814 above to cause to be displayed the first piece of content to the user.

At 906, control circuitry receives a first interaction of the user with the first piece of content. In some embodiments, the control circuitry uses the same or similar methodologies described at step 816 above to receive the first interaction of the user with the first piece of content.

At 908, control circuitry identifies a first object depicted in the first piece of content based, at least in part, on the first object being assigned a first label, the first interaction, and a first object preference. In some embodiments, the control circuitry uses the same or similar methodologies described at step 818 above to identify the first object depicted in the first piece of content.

At 910, control circuitry generates a second piece of content by replacing the first object with a second object. In some embodiments, the control circuitry uses the same or similar methodologies described at step 820 above to generates the second piece of content.

At 912, control circuitry causes to be displayed the second piece of content to the user. In some embodiments, the control circuitry uses the same or similar methodologies described at step 822 above to cause to be displayed the second piece of content.

At 914, control circuitry receives a second interaction of the user with the second piece of content. In some embodiments, the control circuitry uses the same or similar methodologies described at step 802 to receive the second interaction. In some embodiments, the control circuitry receives the second interaction from the device that displays the second piece of content generated at step 910. For example, the device that displays the second piece of content at step 910 may receive a like input while displaying the second piece of content. The devices may then transmit the detected interaction (e.g., like input) and information about the second piece of content (e.g., piece of content identifier) associated with the detected interaction to the control circuitry. In some embodiments, the control circuitry receives the second interaction from one or more other devices. For example, one or more devices may detect user interactions when a user performs a search (e.g., using one or more search engines) related to a product depicted in the second piece of content. The one or more other devices may transmit the detected interaction (e.g., user performing a search related to the depicted product) to the control circuitry.

At 916, control circuitry generates a report comprising the first interaction and the second interaction. In some embodiments, the report comprises the first user interaction received at step 906 and the second user interaction received at step 914. For example, the report may indicate that the user skipped the first piece of content and fully watched the second piece of content. In some embodiments, the report also comprises information about the first piece of content and/or the second piece of content. For example, the report may comprise a first identifier indicating that the first piece of content is the original piece of content, and the second piece of content is a variant of the first piece of content. In some embodiments, the identifiers also indicate one or more changes related to the piece of content. For example, the report may comprise an identifier indicating that first object (e.g., first actor) was changed to a replacement object (e.g., second actor) in the second piece of content.

In some embodiments, the report comprises a plurality of user interactions. For example, the first piece of content and the second piece of content may be shown to a plurality of users. The control circuitry may receive a plurality of user interactions associated with the actions of each user of the plurality of users who viewed the first piece of content and/or the second piece of content. In some embodiments, the control circuitry summarizes the plurality of user interactions for each piece of content. For example, the report may indicate that 60% more users skipped the first piece of content compared to the second piece of content. In some embodiments, different user interactions are assigned different values based on different campaigns.

At 918, control circuitry transmits the report to one or more devices. The report may be transmitted to one or more devices. For example, the control circuitry may transmit the report to the device that provided the first piece of content.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
monitoring a plurality of interactions between a user and a plurality of pieces of content, wherein each piece of content of the plurality of pieces of content depicts at least one object;
determining a first object preference of the user based, at least in part, on at least one interaction of the plurality of interactions, wherein the first object preference is associated with a first object depicted in at least one piece of content of the plurality of pieces of content;
receiving a first piece of content;
extracting a plurality of features from the first piece of content, wherein the plurality of features are associated with a plurality of objects within the first piece of content;
assigning a first label to a first set of objects of the plurality of objects based, at least in part, on a first set of features of the plurality of features, wherein the first label corresponds to non-product objects;
assigning a second label to a second set of objects of the plurality of objects based, at least in part, on a second set of features of the plurality of features, wherein the second label corresponds to product objects;
displaying, by a first device, the first piece of content, wherein the first device is associated with the user;
detecting, by the first device, a first interaction of the user with the first piece of content;
receiving, by a second device, the first interaction;
identifying, by the second device, a first object of the first set of objects based, at least in part, on:
the first object being assigned the first label;
the first interaction; and
the first object preference, wherein the first object preference is associated with the first object;
generating a second piece of content, by replacing the first object of the first set of objects with a second object; and
displaying, by the first device, the second piece of content.

2. The method of claim 1, wherein the second piece of content comprises the second set of objects and one or more objects of the first set of objects.

3. The method of claim 2, wherein identifying the first object of the first set of objects further comprises inputting the first interaction, the first object being assigned the first label, and the first object preference of the user into one or more models.

4. The method of claim 3, wherein generating the second piece of content further comprises:
inputting the first piece of content and an identification of the first object into an artificial intelligence model; and
generating, by way of the artificial intelligence model, the second piece of content, wherein the first object of the first set of objects is replaced with the second object.

5. The method of claim 4, further comprising:
determining a second object preferences of the user based, at least in part, on a second at least one interaction of the plurality of interactions, wherein the second object preference is associated with the second object depicted in at least one piece of content of the plurality of pieces of content; and
inputting the second object preference into the artificial intelligence model, prior to the artificial intelligence model generating the second piece of content.

6. The method of claim 2, further comprising:
receiving, by the second device, a second interaction related to the second piece of content;
generating a third piece of content, by replacing the first object of the first set of objects with a third object, wherein:
the third piece of content is generated based, at least in part, on the second interaction; and
the third piece of content is generated using an artificial intelligence model; and
displaying, by the first device, the third piece of content.

7. The method of claim 6, further comprising:
generating a report comprising the first interaction, the second interaction, and information about the second piece of content; and
transmitting the report to a third device different than the second device.

8. The method of claim 2, further comprising:
receiving, by the second device, a second interaction related to the second piece of content;
generating a third piece of content, by replacing a third object of the first set of objects with a fourth object, wherein:
the third piece of content is generated based, at least in part, on the second interaction; and
the third piece of content is generated using an artificial intelligence model; and
displaying, by the first device, the third piece of content.

9. The method of claim 8, further comprising:
generating a report comprising the first interaction, the second interaction, and information about the second piece of content; and
transmitting the report to a third device different than the second device.

10. The method of claim 2, wherein:
the second set of objects that are assigned the second label corresponding to product objects depict at least one of: a product for sale or a logo; and
the first set of objects that are assigned the first label corresponding to non-product objects do not depict a product for sale or a logo.

11. The method of claim 2, further comprising:
submitting a first bid related to the first device;
receiving a first notification indicating that the first bid was successful;
transmitting the first piece of content to the first device in response to receiving the first notification;
submitting a second bid related to the first device, wherein:
the second bid is a retargeting bid; and
the second bid is submitted based, at least in part, on the first interaction;
receiving a second notification indicating that the second bid was successful; and
transmitting the second piece of content to the first device in response to receiving the second notification.

12. The method of claim 2, further comprising:
receiving, by the second device, a second interaction related to the second piece of content;
determining that no additional content should be generated based, at least in part, on the second interaction; and
transmitting a notification indicating that no additional content should be generated.

13. An apparatus comprising:
control circuitry; and
at least one memory including computer program code for one or more programs, the at least one memory and the computer program code configured to, with the control circuitry, cause the apparatus to perform at least the following:
monitor a plurality of interactions between a user and a plurality of pieces of content, wherein each piece of content of the plurality of pieces of content depicts at least one object;
determine a first object preference of the user based, at least in part, on at least one interaction of the plurality of interactions, wherein the first object preference is associated with a first object depicted in at least one piece of content of the plurality of pieces of content;
receive a first piece of content;
extracting a plurality of features from the first piece of content, wherein the plurality of features are associated with a plurality of objects within the first piece of content;
assign a first label to a first set of objects of the plurality of objects based, at least in part, on a first set of features of the plurality of features, wherein the first label corresponds to non-product objects;
assign a second label to a second set of objects of the plurality of objects based, at least in part, on a second set of features of the plurality of features, wherein the second label corresponds to product objects;
causing to be displayed, at a device associated with the user, the first piece of content;
receive, from the device, a first interaction of the user with the first piece of content;
identifying a first object of the first set of objects based, at least in part, on:
the first object being assigned the first label;
the first interaction; and
the first object preference, wherein the first object preference is associated with the first object;
generate a second piece of content, by replacing the first object of the first set of objects with a second object; and
causing to be displayed the second piece of content.

14.-24. (canceled)

25. A non-transitory computer-readable medium having instructions encoded thereon that, when executed by control circuitry, cause the control circuitry to:
monitor a plurality of interactions between a user and a plurality of pieces of content, wherein each piece of content of the plurality of pieces of content depicts at least one object;
determine a first object preference of the user based, at least in part, on at least one interaction of the plurality of interactions, wherein the first object preference is associated with a first object depicted in at least one piece of content of the plurality of pieces of content;
receive a first piece of content;
extract a plurality of features from the first piece of content, wherein the plurality of features are associated with a plurality of objects within the first piece of content;
assign a first label to a first set of objects of the plurality of objects based, at least in part, on a first set of features of the plurality of features, wherein the first label corresponds to non-product objects;
assign a second label to a second set of objects of the plurality of objects based, at least in part, on a second set of features of the plurality of features, wherein the second label corresponds to product objects;
causing to be displayed, at a device associated with the user, the first piece of content;
receive, from the device, a first interaction of the user with the first piece of content;
identifying a first object of the first set of objects based, at least in part, on:
the first object being assigned the first label;
the first interaction; and
the first object preference, wherein the first object preference is associated with the first object;
generate a second piece of content, by replacing the first object of the first set of objects with a second object; and
causing to be displayed the second piece of content.

26.-48. (canceled)

49. The method of claim 2, wherein detecting, by the first device, the first interaction of the first user with the first piece of content comprises receiving a skip command or a fast forward command.

50. The method of claim 49, wherein:
the first label is assigned to the first set of objects of the plurality of objects using feature mapping and the first set of features of the plurality of features; and
the second label is assigned to the second set of objects of the plurality of objects using feature mapping and the second set of features of the plurality of features.

51. The method of claim 2, wherein:
the first piece of content comprises a plurality of segments;
the first object appears in a first segment of the plurality of segments;
the first interaction is detected by the first device when the first device displays the first segment of the plurality of segments; and
the second device identifies the first object of the first set of objects based, at least in part, on:
the first interaction occurring when the first device displays the first segment of the plurality of segments; and
the first segment comprising the first object.

52. The method of claim 51, wherein detecting, by the first device, the first interaction of the first user with the first piece of content comprises receiving a skip command or a fast forward command.

53. The method of claim 2, wherein:
the first piece of content comprises a plurality of segments;
the first object does not appear in a first segment of the plurality of segments;
the first object appears in a second segment of the plurality of segments;
the first device displays the first segment of the plurality of segments before the second segment of the plurality of segments;
the first interaction is detected by the first device when the first device displays the second segment of the plurality of segments; and
the second device identifies the first object of the first set of objects based, at least in part, on:
the first device displaying the first segment without receiving an interaction;
the first interaction occurring when the first device displayed the second segment of the plurality of segments; and
the second segment comprising the first object.

54. The method of claim 53, wherein detecting, by the first device, the first interaction of the first user with the first piece of content comprises receiving a skip command or a fast forward command.
